(19) United States
(12) Patent Application Publication
(10) Pub. No.: US 2026/0037740 A1
(43) Pub. Date: Feb. 5, 2026

(54) PLUG-AND-PLAY ARCHITECTURE FOR DATA RESOURCE EXTENSIONS IN A NATURAL LANGUAGE INTERFACE SYSTEM

(71) Applicant: Cisco Technology, Inc., San Jose, CA (US)

(72) Inventors: Timothy Simon Stirling, Gilly (CH); Yannick Weibel, Cugy (CH); Sofia Karygianni, Dübendorf (CH)

(73) Assignee: Cisco Technology, Inc., San Jose, CA (US)

(21) Appl. No.: 18/790,039

(22) Filed: Jul. 31, 2024

(51) Int. Cl. G06F 40/35; H04L 67/02

(52) U.S. Cl. CPC G06F 40/35; H04L 67/02

(57) ABSTRACT

In one implementation, a device receives, via a natural language interface agent, an input prompt from a user interface. The device decomposes the input prompt into one or more tasks for performance to produce an answer to the input prompt. The device selects one or more external resources registered in a resource directory for the natural language interface agent based on a semantic relevance between the one or more tasks and information regarding the one or more external resources stored in the resource directory. The device provides the answer to the user interface via the natural language interface agent by performing the one or more tasks using the one or more external resources.

### TECHNICAL FIELD

The present disclosure relates generally to a plug-and-play architecture for data resource extensions in a natural language interface system.

### BACKGROUND

The recent breakthroughs in large language models (LLMs), such as ChatGPT and GPT-4, represent new opportunities across a wide spectrum of industries. More specifically, the ability of these models to follow instructions now allow for interactions with tools (also called plugins) that are able to perform tasks such as searching the web, executing code, etc. In addition, agents can be written to perform tasks by chaining multiple calls to one or more LLMs. For example, a first step can consist in formulating a plan in natural language, and subsequent steps in executing on this plan by writing code to call application programming interfaces (APIs) or libraries.

In the context of monitoring computer networks, these technologies could allow for the development of a natural language interface (NLI) system that can aid an administrator in performing their administrative task. For instance, rather than forcing the administrator to navigate through complex menus to find certain information, the NLI system could simply allow the administrator to issue the query, “what is the AP with the most clients?”

However, implementing an NLI agent for purposes of network monitoring remains challenging due to the complexities involved. Indeed, there may be a wide variety of data sources such as databases, document stores, APIs, other NLI agents, and the like, that the NLI agent needs to access. Beyond this, computer networks are highly dynamic systems and adding new resources to cover new domains and use cases can also prove challenging, as doing so could require frequently retraining and/or fine-tuning the NLI agent.

### BRIEF DESCRIPTION OF THE DRAWINGS

The implementations herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example architecture for a natural language interface (NLI) system;

FIG. 4 illustrates an example of the interactions of the components of the architecture in FIG. 3; and

FIG. 5 illustrates an example simplified procedure for using a resource directory to address an input prompt to an NLI agent.

### DESCRIPTION OF EXAMPLE IMPLEMENTATIONS

### Overview

According to one or more implementations of the disclosure, a device receives, via a natural language interface agent, an input prompt from a user interface. The device decomposes the input prompt into one or more tasks for performance to produce an answer to the input prompt. The device selects one or more external resources registered in a resource directory for the natural language interface agent based on a semantic relevance between the one or more tasks and information regarding the one or more external resources stored in the resource directory. The device provides the answer to the user interface via the natural language interface agent by performing the one or more tasks using the one or more external resources.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

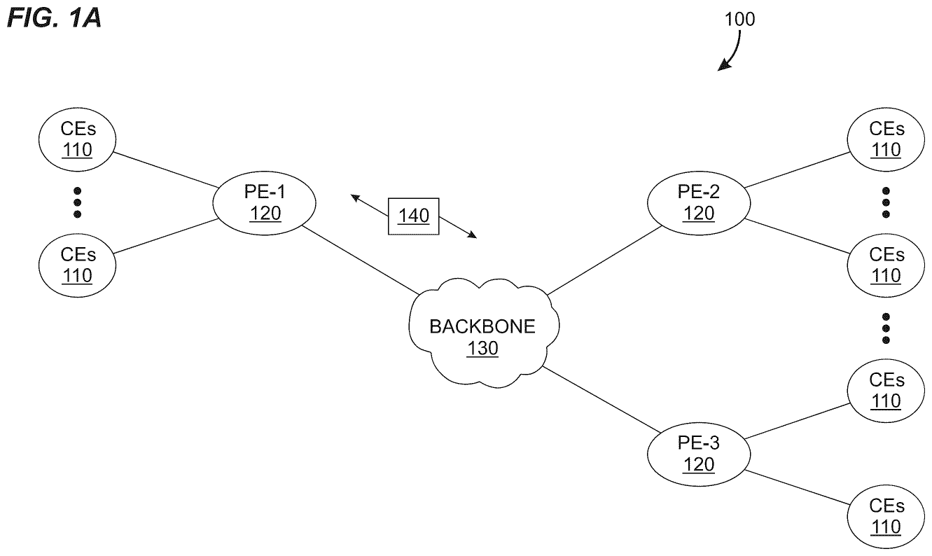

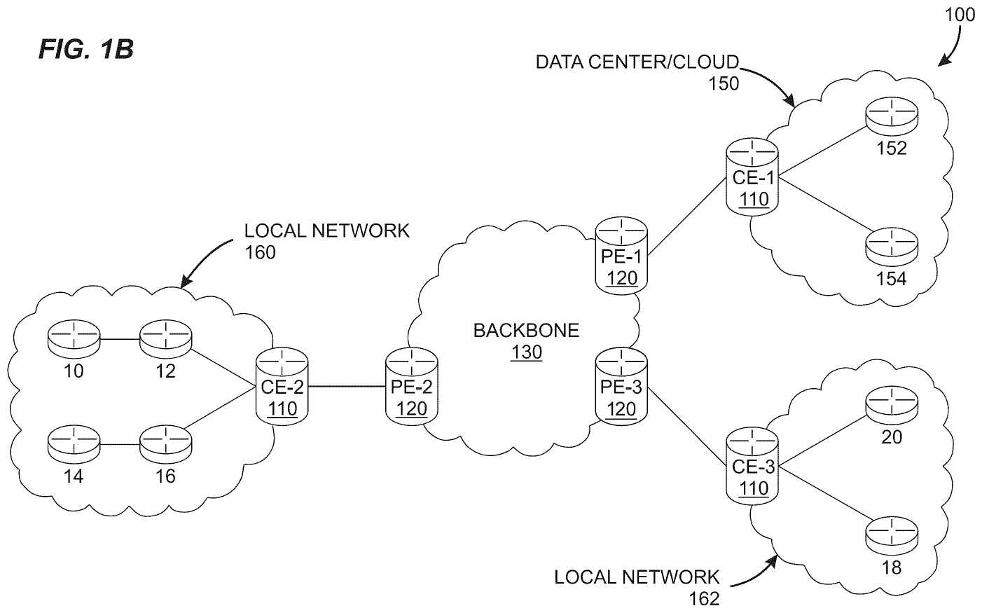

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network by the CE router via two primary links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection). Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various implementations. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

According to various implementations, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

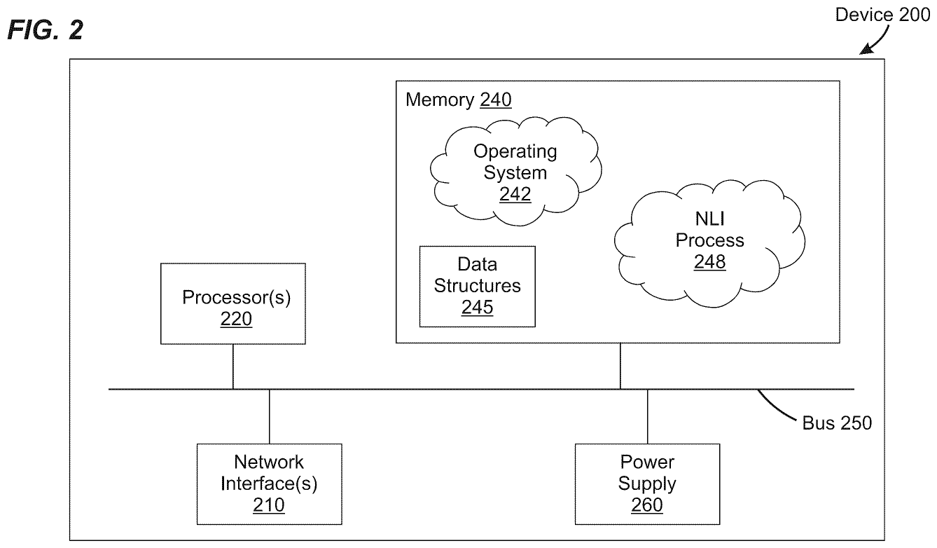

FIG. 2 is a schematic block diagram of an example node/device 200 (e.g., an apparatus) that may be used with one or more implementations described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250 and powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software components may comprise an NLI process 248 as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, NLI process 248 may include computer executable instructions that, when executed by processor(s) 220, cause device 200 to perform the techniques described herein. To do so, in some implementations, NLI process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b+y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, NLI process 248 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that NLI process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, NLI process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. Example generative approaches can include, but are not limited to, generative adversarial networks (GANs), large language models (LLMs), other transformer models, and the like.

As noted above, the recent breakthroughs in LLMs, such as ChatGPT and GPT-4, represent new opportunities across a wide spectrum of industries. More specifically, the ability of these models to follow instructions now allow for interactions with tools (also called plugins) that are able to perform tasks such as searching the web, executing code, etc.

In the specific context of computer networks, though, network troubleshooting and monitoring are traditionally complex tasks that rely on engineers analyzing telemetry data, configurations, logs, and events across a diverse array of network devices encompassing access points, firewalls, routers, and switches managed by various types of network controllers (e.g., SD-WAN, DNAC, ACI, etc.). Moreover, network issues can manifest in various forms, stemming from a multitude of factors, each with its own level of complexity.

The introduction of plugins is a major development that enables LLM-based agents to interact with external systems and empower new domain-specific use cases. In the context of communication networks, the utilization of plugins allows LLMs to engage with documentation repositories, tap into knowledge bases, and interface with live network controllers and devices potentially opening the path to LLMs undertaking more complex tasks such as on-demand troubleshooting, device configuration, and performance monitoring. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

Indeed, in the case of network monitoring, rather than forcing an administrator to navigate through complex menus to find certain information, the system could simply allow the administrator to issue a query such as “what is the AP with the most clients?” However, implementing an NLI system for use with a complex system such as a computer network remains challenging. This is because the pool of available information and resources from which the information can be obtained in such systems is in a constant state of flux, with resources constantly being added or removed over time. Typically, this would require retraining or even fine-tuning the NLI system, which would be impractical in many situations.

### Plug-and-Play Architecture for Data Resource Extensions in an NLI System

The techniques herein introduce a plug-and-play architecture for an NLI system, allowing it to extendable to new resources without the need of extensive retraining. As would be appreciated, retraining can be prohibitively expensive and take a considerable time, thereby constraining how such NLI systems are scaled and extended to new resource domains. This is particularly true in the context of network monitoring, as new resource are added constantly.

Illustratively, the techniques described herein may be performed by hardware, software, and/or firmware, such as in accordance with NLI process 248, which may include computer executable instructions executed by the processor 220 (or independent processor of interfaces 210) to perform functions relating to the techniques described herein.

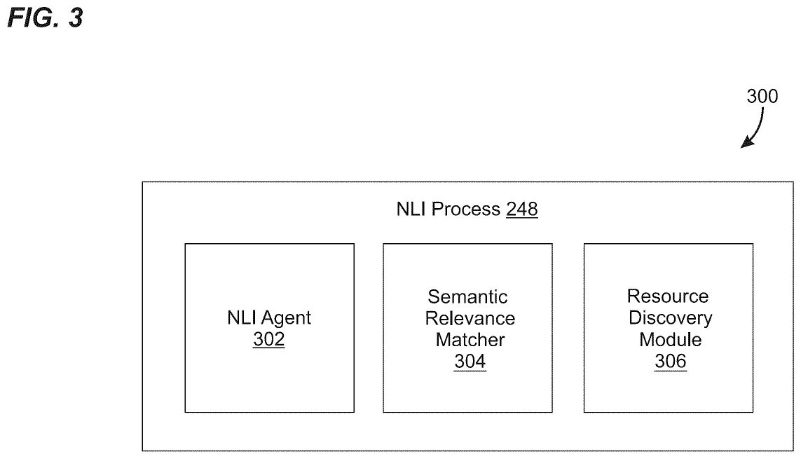

Operationally, FIG. 3 illustrates an example architecture for a natural language interface (NLI) system. At the core of architecture 300 is NLI process 248, which may be executed by a controller for a network, a networking device (e.g., a router, gateway, switch, etc.), an endpoint, a server, or the like.

As shown, NLI process 248 may include any or all of the following components: NLI agent 302, semantic relevance matcher 304, and/or resource discovery module 306. As would be appreciated, the functionalities of these components may be combined or omitted, as desired. In addition, these components may be implemented on a singular device or in a distributed manner, in which case the combination of executing devices can be viewed as their own singular device for purposes of executing NLI process 248.

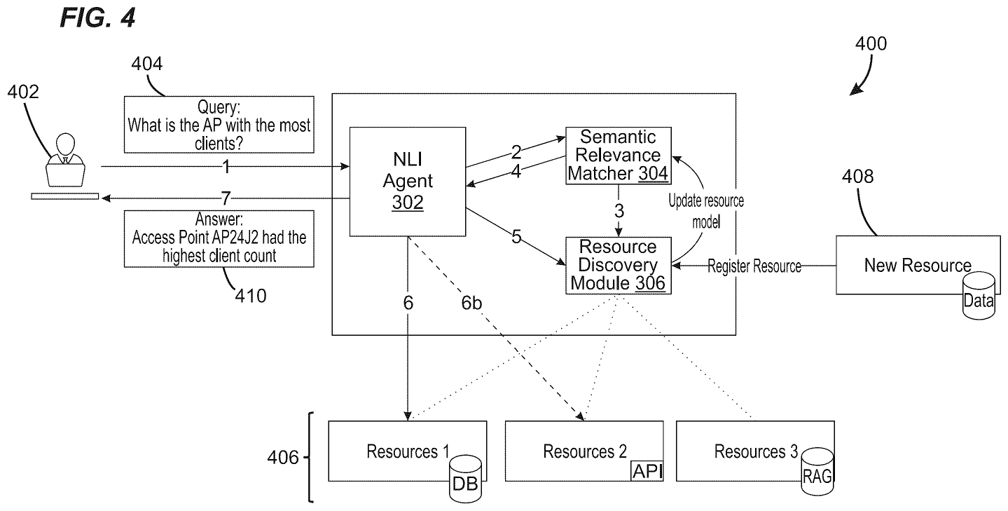

FIG. 4 illustrates an example 400 of the interactions of the components of the architecture in FIG. 3, in various implementations. For NLI agent 302 to provide an effective interface for a complex system such as a computer network, it needs to have knowledge of the resources available to it: the domain, what sources are available, what each resource can be used for, how to interface with each of them, and the like. Here, a resource could be anything such as, but not limited to, data sources like databases or document stores, application programming interfaces (APIs), other NLI agents, and the like.

By way of example, consider the case of a computer network for which there may be any number of devices or services accessible via APIs or command line interface (CLI) commands, documents regarding the network and its components, etc., that are available both internally within the network and outside of the network. The full set of such resources may change considerably over time, as new devices are added to the network, devices are updated, new documentation is released, etc. Thus, implementing an NLI for purposes of monitoring, or even troubleshooting or administering, the network would be very difficult, as the NLI agent would need to be updated each time a resource is added or removed.

To this end, NLI agent 302 may interact with semantic relevance matcher 304 and resource discovery module 306, which operate in conjunction with one another to implement an NLI system that supports the addition and removal of resources in a plug-and-play manner. More specifically, resource discovery module 306 may be responsible for keeping track of the available resources and their associated information. Likewise, semantic relevance matcher 304 may be responsible for helping NLI agent 302 to decide which of those resources should be used to answer a given input prompt, based on their relevance to the prompt.

Every new resource that is required to be added to the system may be registered via resource discovery module 306 and described appropriately in its resource directory. In some implementations, the resource directory may take the form of a database with metadata about the resources and examples of their use. The metadata could differ per resource, but it should be descriptive enough to ensure the association of the resource with the relevant tasks that NLI agent 302 could perform using that resource, as well as information regarding its reachability (e.g., how to access that resource). Any number of language models may support the operation of NLI agent 302. For instance, in one implementation, NLI agent 302 may rely on a large language model (LLM) to perform its operations.

By way of example, assume that resource discovery module 306 has registered an existing set of resources 406 such as a database resource, an API-based resource, a retrieval augmented generation (RAG)-based resource, or other resource. In the case of the database resource, the resource directory maintained by resource discovery module 306 may include information about the schema of the database, the host of the database, any required credentials to access the database, example queries to the database, etc. The database content may be described within the resource directory well enough to convey at least a general description of its contents, a description of each of its tables, its table schemas, and/or descriptions of its table fields.

When a user issues an input prompt to NLI agent 302, NLI agent 302 may decompose the prompt into separate, simpler tasks that it needs to perform in order to generate a corresponding answer. In doing so, the task(s) will have reduced scope and domain-specific requirements that might map to a specific resource. Then, semantic relevance matcher 304 may be responsible for retrieving the appropriate resources that are the most relevant to each task from the resource discovery module 306.

In one implementation, semantic relevance matcher 304 may take the form of an embedding model based on the resource metadata in the resource directory of resource discovery module 306. In this case, newly added resources are immediately available to NLI agent 302 once they are added in the embedding model, which is a straightforward task with many implementation possibilities as utilized in RAG systems.

In another implementation, semantic relevance matcher 304 could be a continually adaptive retrieval system based on a neural database. Leveraging neural databases mitigates the need to compute and maintain large embedding databases by using a neural network to predict semantically relevant resource metadata in resource directory of resource discovery module 306 from user queries. An advantage of neural databases is that they can efficiently scale up to billions of records and are easily updated continuously, thereby adding new resources is trivial and does not require rebuilding an embedding tree. Initial training of the neural database can be achieved automatically by using an LLM to generate semantically relevant sample queries from the metadata of a new resource added to the directory. This is scalable because the entire system does not require retraining but only pre-processing of the newly added resources added to the resource directory.

Importantly, the NLI system only requires end-to-end training once so that the NLI agent 302 can learn to decompose user queries into tasks and use semantic relevance matcher 304 and resource discovery module 306 to map tasks to relevant tools and resources. During training, NLI agent 302 may be trained to submit every decomposed task of an input prompt to semantic relevance matcher 304 and receive its proposals for the appropriate resource to use before taking any action. Once the resource proposals are received, NLI agent 302 may even be trained to use resource discovery module 306 directly to retrieve the appropriate method to utilize the selected tool. NLI agent 302 may then aggregate the information from the different tools and create an answer before returning it to the user.

By way of example, consider the case in which a user 402 submits an input prompt 404 to NLI agent 302 at step (1) by operating a user interface (e.g., a computer, a tablet, a phone, etc.). Typically, input prompt 404 includes a query that requests information from the NLI system or that the NLI system accomplish some goal (e.g., exerting control over some underlying system, such as a computer network). For instance, as shown, user 402 may ask the query “what is the AP with the most clients?”

In response to receiving input prompt 404, NLI agent 302 may then decompose the prompt into a set of one or more tasks. For instance, in the case of identifying the wireless access point with the most clients, this may first require performing tasks such as obtaining a list of the access points in the corresponding network, determining which of those access points have attached clients and, if so, how many, then sorting the results to identify the access point with the most clients. Of course, performance of each of these tasks may also require accessing different resources 406.

Once NLI agent 302 has decomposed input prompt 404, it may at (2) ask semantic relevance matcher 304 to select the most relevant resources 406 to perform each of the task(s). For instance, identifying the various access points in the network may require making an API call to a network controller, wireless LAN controller, or other supervisor for the access points. However, obtaining specific information about the clients attached to a specific access point may require making a call to that access point or to a different entity in the network. Semantic relevance matcher 304 at (3) then uses its own internal model and the resource directory of resource discovery module 306 to select the best resource(s) per task.

Semantic relevance matcher 304 may then propose its selections from among resources 406 to NLI agent 302 at step (4). If need be, NLI agent 302 may then query the directory of resource discovery module 306 at step (5) for information as to how to interact with these resources. In other implementations, semantic relevance matcher 304 could include this information in its recommendations to NLI agent 302. For example, a text-to-SQL tool can create valid SQL code that can be executed against a database with the host and credentials specified in resource discovery module 306, thereby permitting NLI agent 302 to make valid calls against a database resource. Alternatively, a document search tool can return the top-K text chunks in a documentation corpus, with the details of the endpoint and API described in the directory of resource discovery module 306.

NLI agent 302 then uses the resource information for the selected resource(s) to gather the required information and perform its tasks. For instance, at step (6), NLI agent 302 may perform a database lookup of a first database in resources 406 and at step (6b) then make an API call to another resource.

Using the results of the tasks, NLI agent 302 may then construct an answer 410 and return it to the user interface of 402 at step (7). For instance, in response to the query of input prompt 404, answer 410 may indicate that access point ‘AP24J2’ has the highest client count.

In various implementations, when a new resource 408 becomes available, resource discovery module 306 may add its information to the resource directory and update the resource model that semantic relevance matcher 304 uses, accordingly. To do so, resource discovery module 306 may register information regarding new resource 408 such as its domain, a specification as to how NLI agent 302 is to interact with it, examples of how to use new resource 408, or the like. Doing so makes new resource 408 automatically available for use by NLI agent 302 without requiring any additional updating of its model.

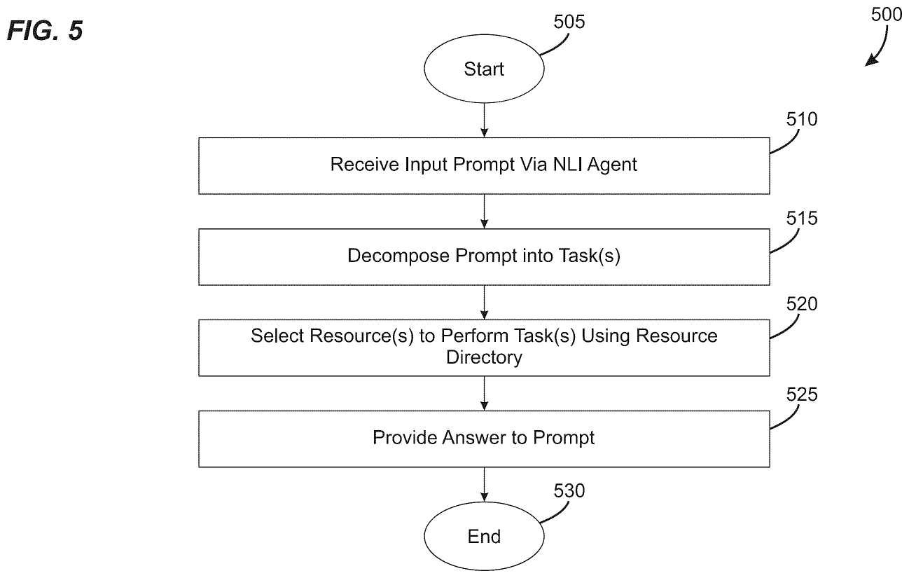

FIG. 5 illustrates an example simplified procedure 500 (e.g., a method) for using a resource directory to address an input prompt to an NLI agent, in accordance with one or more implementations described herein. For example, a non-generic, specifically configured device (e.g., device 200), such as a router, firewall, controller for a network, endpoint, server, or the like, may perform procedure 500 by executing stored instructions (e.g., NLI process 248). The procedure 500 may start at step 505, and continues to step 510, where, as described in greater detail above, the device may receive, via a natural language interface agent, an input prompt from a user interface. In one example, the input prompt requests information regarding a computer network.

At step 515, as detailed above, the device may decompose the input prompt into one or more tasks for performance to produce an answer to the input prompt. In various implementations, the natural language interface agent uses a large language model (LLM) to perform the one or more tasks.

At step 520, the device may select one or more external resources registered in a resource directory for the natural language interface agent based on a semantic relevance between the one or more tasks and information regarding the one or more external resources stored in the resource directory, as described in greater detail above. In one implementation, the one or more tasks comprises making an application programming interface (API) call to a particular resource from among the one or more external resources. In another implementation, the one or more tasks comprises performing a database lookup using a particular resource from among the one or more external resources. In a further implementation, the one or more external resources comprise a retrieval augmented generation (RAG) system. In yet another implementation, the one or more external resources comprises a controller for a computer network. In some cases, the resource directory is stored in a neural database.

At step 525, as detailed above, the device may provide the answer to the user interface via the natural language interface agent by performing the one or more tasks using the one or more external resources. In various implementations, the device may also register a new external resource in the resource directory. In some cases, the device may do so by registering at least one of: a domain of the new external resource or a specification as to how to interact with the new external resource in the resource directory.

Procedure 500 then ends at step 530.

While there have been shown and described illustrative implementations that provide for a plug-and-play architecture for data resource extensions in a natural language interface system, it is to be understood that various other adaptations and modifications may be made within the spirit and scope of the implementations herein. For example, while certain implementations are described herein with respect to using certain models for purposes of generating CLI commands, making API calls, charting a network, and the like, the models are not limited as such and may be used for other types of predictions, in other implementations. In addition, while certain protocols are shown, other suitable protocols may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method comprising:
receiving, at a device and via a natural language interface agent, an input prompt from a user interface;
decomposing, by the device, the input prompt into one or more tasks for performance to produce an answer to the input prompt;
selecting, by the device, one or more external resources registered in a resource directory for the natural language interface agent based on a semantic relevance between the one or more tasks and information regarding the one or more external resources stored in the resource directory; and
providing, by the device, the answer to the user interface via the natural language interface agent by performing the one or more tasks using the one or more external resources.

2. The method as in claim 1, wherein the natural language interface agent uses a large language model (LLM) to perform the one or more tasks.

3. The method as in claim 1, wherein the one or more tasks comprises making an application programming interface (API) call to a particular resource from among the one or more external resources.

4. The method as in claim 1, wherein the one or more tasks comprises performing a database lookup using a particular resource from among the one or more external resources.

5. The method as in claim 1, further comprising:
registering, by the device, a new external resource in the resource directory.

6. The method as in claim 5, wherein the device registers at least one of: a domain of the new external resource or a specification as to how to interact with the new external resource in the resource directory.

7. The method as in claim 1, wherein the one or more external resources comprise a retrieval augmented generation (RAG) system.

8. The method as in claim 1, wherein the resource directory is stored in a neural database.

9. The method as in claim 1, wherein the one or more external resources comprises a controller for a computer network.

10. The method as in claim 1, wherein the input prompt requests information regarding a computer network.

11. An apparatus, comprising:
one or more network interfaces;
a processor coupled to the one or more network interfaces and configured to execute one or more processes; and
a memory configured to store a process that is executable by the processor, the process when executed configured to:
receive, via a natural language interface agent, an input prompt from a user interface;
decompose the input prompt into one or more tasks for performance to produce an answer to the input prompt;
select one or more external resources registered in a resource directory for the natural language interface agent based on a semantic relevance between the 12 one or more tasks and information regarding the one or more external resources stored in the resource directory; and
provide the answer to the user interface via the natural language interface agent by performing the one or more tasks using the one or more external resources.

12. The apparatus as in claim 11, wherein the natural language interface agent uses a large language model (LLM) to perform the one or more tasks.

13. The apparatus as in claim 11, wherein the one or more tasks comprises making an application programming interface (API) call to a particular resource from among the one or more external resources.

14. The apparatus as in claim 11, wherein the one or more tasks comprises performing a database lookup using a particular resource from among the one or more external resources.

15. The apparatus as in claim 11, wherein the process when executed is further configured to:
register a new external resource in the resource directory.

16. The apparatus as in claim 15, wherein the apparatus registers at least one of: a domain of the new external resource or a specification as to how to interact with the new external resource in the resource directory.

17. The apparatus as in claim 11, wherein the one or more external resources comprise a retrieval augmented generation (RAG) system.

18. The apparatus as in claim 11, wherein the resource directory is stored in a neural database.

19. The apparatus as in claim 11, wherein the one or more external resources comprises a controller for a computer network.

20. A tangible, non-transitory, computer-readable medium storing program instructions that cause a device to execute a process comprising:
receiving, at the device and via a natural language interface agent, an input prompt from a user interface;
decomposing, by the device, the input prompt into one or more tasks for performance to produce an answer to the input prompt;
selecting, by the device, one or more external resources registered in a resource directory for the natural language interface agent based on a semantic relevance between the one or more tasks and information regarding the one or more external resources stored in the resource directory; and
providing, by the device, the answer to the user interface via the natural language interface agent by performing the one or more tasks using the one or more external resources.
